(19) United States
(12) Patent Application Publication
(10) Pub. No.: US 2025/0363793 A1
(43) Pub. Date: Nov. 27, 2025

(54) RESIDUAL AND ATTENTIONAL ARCHITECTURES FOR VECTOR-SYMBOLS

(71) Applicant: THE REGENTS OF THE UNIVERSITY OF CALIFORNIA, Oakland, CA (US)

(72) Inventors: Maksim BAZHENOV, San Diego, CA (US); Wilkie OLIN-AMMENTORP, Manlius, NY (US)

(21) Appl. No.: 18/874,039

(22) PCT Filed: Jun. 14, 2023
(86) PCT No.: PCT/US2023/025275

§ 371 Date: Dec. 11, 2024

Related U.S. Application Data
(60) Provisional application No. 63/352,029, filed on Jun. 14, 2022.

(51) Int. Cl. G06V 10/82; G06N 3/045; G06N 3/084; G06V 10/72; G06V 10/74; G06V 10/764

(52) U.S. Cl. CPC G06V 10/82; G06N 3/045; G06N 3/084; G06V 10/72; G06V 10/761; G06V 10/764

(57) ABSTRACT

Embodiments of the presently disclosed technology provide systems and methods for naturally integrating Vector Symbolic Architectures (VSAs) with neural networks using residual and attentional neural networks. Accordingly, embodiments can construct residual and attention-based neural network architectures for processing VSA-symbols that provide powerful and scalable methods for learning complex mappings. Such VSA-neural network integration may be achieved more naturally with residual and attentional networks than would be possible via integration with convolutional neural networks.

### CROSS-REFERENCE TO RELATED APPLICATIONS

The present application is a U.S. national phase of PCT International Patent Application No. PCT/US2023/025275, filed Jun. 14, 2023 and titled “RESIDUAL AND ATTENTIONAL ARCHITECTURES FOR VECTOR-SYMBOLS”, which claims priority to U.S. Provisional Patent Application No. 63/352,029, filed on Jun. 14, 2022, the contents of which are incorporated herein by reference in their entirety.

### STATEMENT REGARDING FEDERALLY SPONSORED R&D

This invention was made with government support under Grant No. N00014-16-1-2829, awarded by Office of Naval Research (ONR), and Grant No. HR0011-18-2-0021 awarded by the Defense Advanced Research Project Agency (DARPA). The government has certain rights in the Invention.

### TECHNICAL FIELD

Various embodiments generally relate to neural network architectures. More particularly, various embodiments are related to residual and attentional neural network architectures for processing vector-symbols.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 depicts an example graph, in accordance with embodiments of the disclosed technology.

FIG. 2 depicts another example graph, in accordance with embodiments of the disclosed technology.

FIG. 3 depicts an example deep neural network architecture, in accordance with various embodiments of the present disclosure.

FIG. 4 depicts an example graph, in accordance with various embodiments of the present disclosure.

FIG. 5 depicts an example self-attention neural network architecture, in accordance with embodiments of the disclosed technology.

FIG. 6 depicts an example cross-attention neural network architecture, in accordance with embodiments of the disclosed technology.

FIGS. 7A-7C depict a series of diagrams illustrating how embodiments of the presently disclosed technology may be utilized for image classification.

FIGS. 8A-8C depict a series of diagrams illustrating how embodiments of the presently disclosed technology may be utilized for drug toxicity prediction.

FIG. 9 depicts an example graph, in accordance with various embodiments of the present disclosure.

FIG. 10 depicts a table displaying results from example experiments conducted in accordance with embodiments of the disclosed technology.

FIGS. 11A-11C depict a series of diagrams and graphs, in accordance with various embodiments of the present disclosure.

FIGS. 12A-12E depict a series of graphs, in accordance with various embodiments of the present disclosure.

FIGS. 13A-13E depict a series of graphs, in accordance with various embodiments of the present disclosure.

FIGS. 14A-14D depict a series of images and graphs, in accordance with various embodiments of the present disclosure.

FIG. 15 depicts an example computing component, in accordance with various embodiments of the present disclosure.

### DETAILED DESCRIPTION OF THE EMBODIMENTS

Vector-symbolic architectures (VSAs) have been undergoing renewed interest due to their potential use as a ‘common language’ for neuromorphic computing (as used herein, neuromorphic computing may refer to systems/methods of computing where elements of a computer are modeled after biological systems in the human brain and nervous system). Typically, a VSA uses ‘hyperdimensional’ VSA-symbols to represent information (as used herein a VSA-symbol may refer to a hyperdimensional symbol used to represent information in a VSA). Sets of these VSA-symbols can then be manipulated and reduced via operations termed ‘binding’ and ‘bundling.’ These operations can produce composite VSA-symbols encoding complex data structures such as sets, images, graphs, and more. A VSA may also include a ‘similarity’ operation which provides a metric to capture how closely two VSA-symbols relate to one another.

Researchers have applied VSA-based techniques to a variety of problems, such as similarity estimation, classification, analogical reasoning, and more. Certain recent approaches have explored integrating VSA-based techniques with neural networks to improve the neural networks' problem-solving capabilities. Such integration may involve applying neural networks to transform/process VSA-symbols.

In general, neural networks can be utilized to map symbols between different domains (e.g., converting an 8-bit color image into a symbol). Neural networks can also convert symbols from one informational domain into another informational domain (e.g., converting a symbol representing an image into a symbol representing a label).

A challenge with applying a neural network to a given problem (e.g., transforming VSA-symbols) is that changing the architecture of the neural network is often required for the neural network to satisfactorily solve the given problem. More ‘difficult’ problems (e.g., integrated a neural network with a VSA/transforming VSA-symbols) can require neural networks that are scaled up efficiently and effectively. Typically, such ‘scaling up’ has been achieved via the use of convolutional neural networks/convolutional layers (as used herein, a convolutional neural network may refer to a class of deep neural network based on a shared-weight architecture of convolution kernels that slide along input features and provide translation-equivariant responses known as feature maps; a convolutional layer is a core building block of a convolutional neural network). However, as embodiments of the presently disclosed technology are designed in appreciation of, convolutional neural networks may be ill-suited for integration with VSAs, transforming/processing VSA-symbols, etc. One reason for such ill-fit is that VSAs are inherently designed to provide distributed representations of information. Such design conflicts with the design of convolutional neural networks which extract local correlations from inputs via the use of convolutional kernels. A second reason that convolutional neural networks may be ill-suited for integration with VSAs is that convolutional neural networks often change scale by using differently-shaped convolutional kernels and feature maps at each convolutional layer. This contrasts with VSAs, which maintain the dimensionality of a VSA-symbol at each processing step. This feature of VSAs can make them good candidates for neuromorphic hardware (and in some instances, better candidates than convolutional neural networks), as the neuromorphic hardware would not have to be designed to account for primitives which can change shape during processing. Accordingly, performance and efficiency for the neuromorphic hardware may be improved.

Against this backdrop, embodiments of the presently disclosed technology provide systems and methods for naturally integrating VSAs with neural networks using residual and attentional neural networks. Accordingly, embodiments can construct residual and attention-based neural network architectures for processing VSA-symbols that provide more powerful and scalable methods for learning complex mappings. As will be described below, such VSA-neural network integration may be achieved more naturally with residual and attentional networks than would be possible via integration with convolutional neural networks.

In various embodiments, VSA-neural network integration may be achieved within the domain of a Fourier Holographic Reduced Representation (FHRR) VSA. As will be described in greater detail below, use of the FHRR VSA can allow resulting FHRR VSA attentional neural networks to remain compatible with potential neuromorphic hardware. FHRR VSA attentional neural networks in accordance with embodiments may also be used to address problems from different domains (e.g., image classification and molecular toxicity prediction) by encoding different information into the FHRR VSA attentional neural networks' inputs. Such an application of VSAs may provide a potential path to implementing state-of-the-art neural models on neuromorphic hardware.

Fourier Holographic Reduced Representation: As described above, various embodiments of the presently disclosed technology may adapt the use of the FHRR VSA for VSA-symbolic representations and integration with neural networks. Embodiments may leverage the FHRR VSA as it can be efficiently implemented via deep learning frameworks, performs well empirically, and has unique links to spiking neural networks. In the FHRR VSA, each element of a VSA-symbol represents an angular value. Embodiments may normalize these values by π to represent angles on the domain [−1, 1]. Angular values can thus be converted into a complex number via Euler's formula e^{iπx=cos πx+i sin πx, where i represents the complex unit and x is a vector of radian-normalized angles. To measure the similarity (abbreviated to ‘sim.’ in formulas) between two FHRR VSA-symbols a and b with n elements, embodiments may find the mean value of the cosine of element-wise angular differences using example Eq.} 1 below:

$$s i m . ( a , b ) = \frac{1}{n} {\sum }_{i = 1}^{n} ( cos {a}_{i} - {b}_{i} ) ; \qquad Eq . 1$$

Here, two FHRR VSA-symbols can be identical (i.e., similarity values of 1.0) or unrelated (similarity values close to 0.0). VSA-symbols in the FHRR can also be ‘opposing’ (i.e., similarity values of −1.0).

To produce one VSA-symbol which is maximally similar to a set of inputs, embodiments may use the bundling operation (+). In particular, embodiments may stack a set of m input vectors with dimensionality n into a single m×n matrix A. This matrix of radian-normalized angles may be converted to complex values and summed along its first axis. Embodiments may then take the angle of the resulting row vector to produce a single new VSA-symbol from the input set, as illustrated by example Eq. 2 below.

$$+ ( A ) = angle ( {\sum }_{j = 1}^{m} exp ( i π {A}_{j , :} ) ; \qquad Eq . 2$$

Embodiments may use a binding operation (×) to combine concepts represented by different VSA-symbols into a new VSA-symbol dissimilar to its inputs. Using the binding operation (×), embodiments may ‘rotate’ the angles in an input symbol a by those in a separate ‘displacement’ vector, b. Fractional binding can be accomplished by including a power p, which multiplies the amount by which the displacement vector rotates the input. Embodiments may use these operations to encode continual values within a vector-symbolic representation, as illustrated by example Eq. 3 below (here normal binding may use a power of 1.0).

$$\times ( a , b , p ) = ( {a}_{i} + p \cdot {b}_{i} + 1 ) \%2 - 1 ; \qquad Eq . 3$$

As will be described in greater detail below, embodiments can use the foregoing operations and their sub-components (e.g., matric multiplication) to create trainable and effective neural models with deep and attentional mechanisms.

Generalized Bundling: In various examples, embodiments may represent/process the bundling function in a more general form (i.e., a “generalized bundling function,” which may also be referred to herein as a generalized bundling activation function, or a ‘phasor’ activation function) to allow it to serve as the basis for a trainable neural layer. As described above, embodiments may take m input VSA-symbols with n angles as inputs (represented as an m×n matrix A), which can then be converted into the complex domain. By including an n×o matrix of projection weights Wp, embodiments can project the complex values into a new m×p output space. To reduce or expand these projected values, embodiments can include an r×m set of reduction weights Wr (see e.g., Eq. 4 below).

$$+ ( A , {W}_{r} , {W}_{p} ) = angle ( {W}_{r} \cdot exp ( i π A ) \cdot {W}_{p} ) ; \qquad Eq . 4$$

If Wr is an 1×m matrix of ones and Wp is an n×n identity matrix, this “generalized” bundling function reduces back to the previous case (see e.g., Eq. 2). If instead however Wr is an m×m identity matrix and Wp is a trainable n×p matrix, embodiments can use generalized bundling as a neural layer with a non-linear activation function which produces an m×p output from an m×n input A. As will be described in greater detail below in conjunction with the supplemental disclosure entitled “Deep Phasor Networks: Connecting Conventional and Spike Neural Networks,” embodiments may demonstrate the use of this generalized bundling neural layer to produce effective neural networks which can be executed via spiking dynamics.

To summarize above, and as will be described in greater detail below, the foregoing generalized bundling function may be utilized as a basis for all fully-connected neural layers (i.e., generalized bundling neural layers) of attentional neural networks in accordance with embodiments of the presently disclosed technology.

Residual Layers: When generalized bundling neural layers are stacked into deeper neural networks, certain issues may arise. For example, the conditioning of deeper neural networks may reduce, and the deeper neural networks may become difficult/impossible to train in practice. Embodiments may address these issues through introduction of residual blocks. Residual blocks can modify one or more neural layers so that when using initial weights, the outputs from the neural layers approximate the identity function. This may be achieved by using a ‘skip’ connection to add/bind the input values of a residual block to its outputs as the output of a neural layer (here the residual block may be a neural layer) with random weights and most common activation functions is approximately zero.

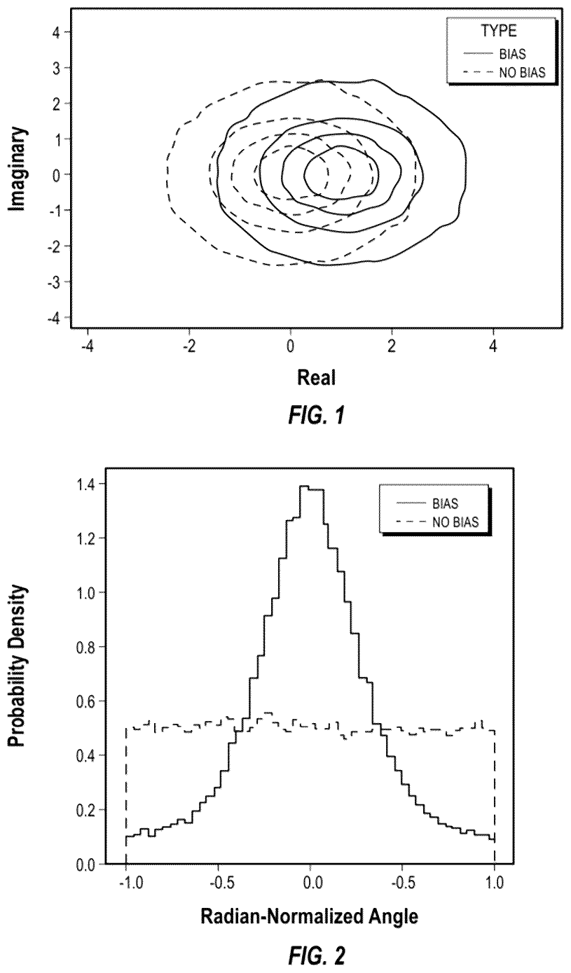

Adapting the presently disclosed generalized bundling neural layers to form residual blocks may encounter a few practical challenges. For example, a zero-centered random initializer (Gaussian, uniform, or otherwise) in a generalized bundling neural layer will typically weight and sum a set of inputs to produce a complex value which is centered on the origin of the complex plane (see e.g., FIG. 1). As a result, the generalized bundling activation function operating with initial random projection weights will produce values which are not normally distributed around zero, but uniformly distributed random angles. Such a distribution violates one of the requirements for a residual block: that a neural layer will initially produce values narrowly centered on zero.

To address this challenge, embodiments can add a complex bias to the generalized bundling function. This bias can shift the distribution of initial complex values. In various examples, embodiments may set the bias to move the origin of projected values from 0+0i to 1+0i (see e.g., FIG. 1). Given this change, the distribution of angular values produced by generalized bundling becomes normally centered around zero (see e.g., FIG. 2). With this change, a skip connection operating on the output of a generalized bundling neural layer can approximate the identity function. Additionally, embodiments can substitute the VSA ‘binding’ operation on the output of the generalized bundling neural layer to replace addition, as the former restricts the output to be on the VSA's domain and allows the computation to remain compatible with neuromorphic hardware which implements VSA operations (as opposed to/instead of arbitrary mathematical operations). Such substitution can produce a residual block which solely employs operations used within the VSA.

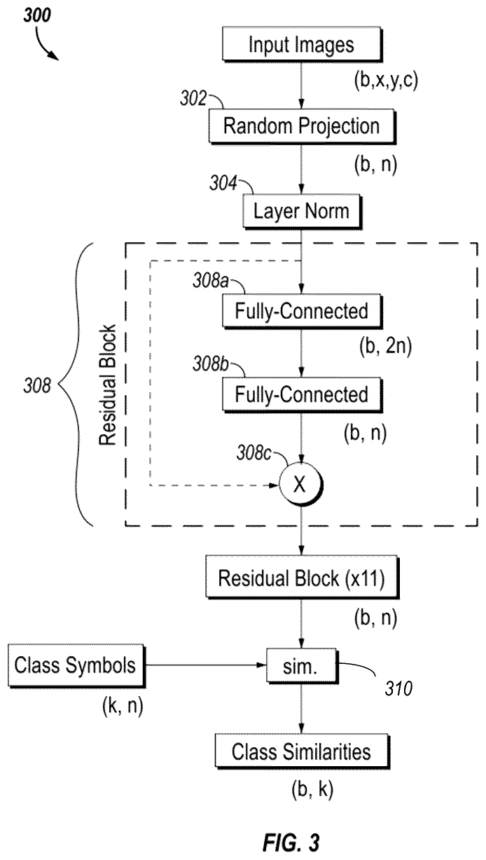

Embodiments can validate the foregoing approach by using a simple image classification task. For example, embodiments may transform images from the FashionMNIST dataset into FHRR VSA-symbols using Gaussian random projection and Layer Norm. These FHRR VSA-symbols can be processed via successive autoencoding multi-layer perceptron (MLP) blocks. Each block may contain one hidden neural layer twice the width of a FHRR VSA-symbol (2n) and an output neural layer which reduces the FHRR VSA-symbol back to the symbol dimensionality n. Both neural layers' outputs may be calculated via the generalized bundling function. These blocks may be followed by a skip connection to create a residual neural network. Embodiments may compare the final output FHRR VSA-symbol to a set of random symbols representing each image class. The class the output is most similar to may then be taken as the predicted label (see e.g., FIG. 3). Embodiments may calculate loss by comparing the similarity of the neural network's output to the FHRR VSA-symbol corresponding to the correct class.

Referring now to FIG. 3, FIG. 3 may depict an example deep neural network architecture 300, in accordance with various embodiments of the present disclosure. Deep neural network architecture 300 includes residual block 308 comprised of two fully-connected neural layers 308a and 308b and a skip connection 308c. Deep neural network architecture 300 also includes a random projection transformation 302, a layer normalization transformation 304, and similarity operation 310. The parentheses depicted after each block may represent the ‘shape’ of the outputs from the block (where the shape has changed). Here, ‘b’ may represent batch size, ‘x’ and ‘y’ may represent the horizontal and vertical dimensions of an image, ‘c’ may represent the image's number of color channels, ‘n’ may represent the length of a VSA-symbol, and ‘k’ may represent the number of class labels.

As depicted, deep neural network architecture 300 may first flatten input images and project them to the dimensionality of the vector space being used (n) (in various embodiments, this transformation may be achieved via random projection transformation 302). The resultant VSA-symbols may then be normalized into [−1, 1] using a LayerNorm (in various embodiments, this transformation may be achieved via layer normalization transformation 304). These normalized VSA-symbols may then pass through residual block 308 consisting of two fully-connected layers 308a and 308b (as described above, fully-connected layers 308a and 308b may be based on the generalized bundling function) and skip connection 308c. The similarity of the residual block's outputs may then be compared to class symbols, yielding a prediction for each image's class (in various embodiments, this operation may be achieved via similarity operation 310).

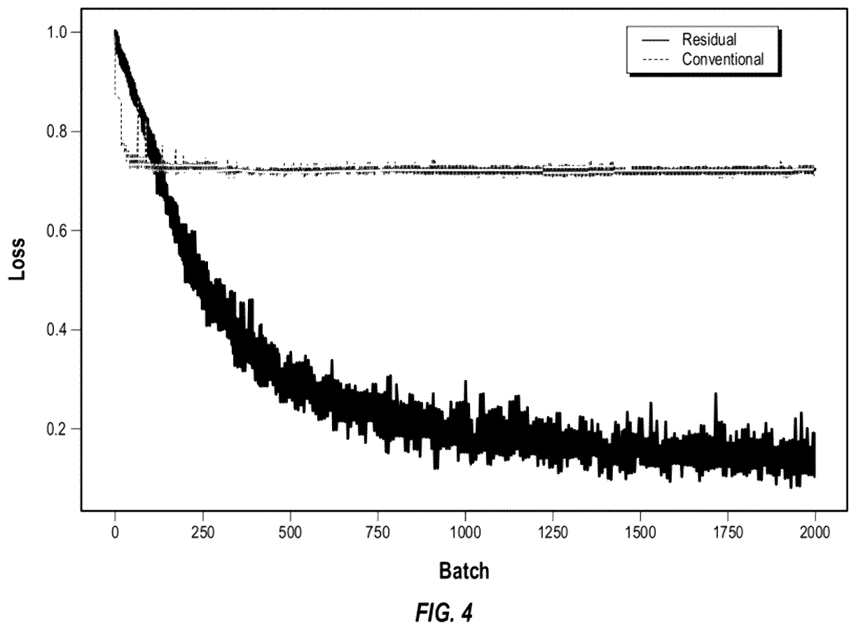

The improved conditioning induced by applying a VSA binding-based skip connection can allow deep neural networks to become more trainable (see e.g., FIG. 4). For example, in example experiments a neural network using generalized bundling neural layers and VSA residual blocks with 24 total layers was demonstrated to reach 85.8% test accuracy on the FashionMNIST test split. By contrast, when the skip connections were removed the model did not exceed chance levels of classification accuracy. Accordingly, the presently disclosed use of skip connections/residual blocks can improve neural network prediction accuracy.

Attention Mechanisms: A feature of certain recent advances in natural language processing (NLP) tasks is “attention.” Attention may refer to the ability to compute intermediate representations of inputs and calculate how those intermediate representations relate to one another and should be used to adjust information which is passed downstream. The ability of neural networks utilizing attention to learn arbitrary, non-local relationships has enabled a new state-of-the-art in NLP tasks, and attention-based architectures continue to be extended into areas historically dominated by convolutional networks such as image recognition. Furthermore, by applying attention mechanisms to transfer information from arbitrarily-shaped inputs into a fixed latent space, the application of attention-based ‘Perceiver’ models has demonstrated these architectures' potential as a ‘universal’ model which can answer complex queries on different tasks such as image classification, video compression, image flow, and more.

Certain attention-based architectures employ the popular ‘query-key-value’ (QKV) attention mechanism, which uses three inputs to produce a single output. For this mechanism, matrix multiplication is carried out between queries (Q) and keys (K). This matrix can then be scaled by the dimensionality of the keys (dk) for numerical stability. Its softmax may then be taken to calculate a set of scores, which can represent the relevance between a given query and key. Matrix multiplication of the scores and values (V) then produces the output of the attention mechanism (see e.g., Eq. 5 below).

$$Attention ( Q , K , V ) = softmax ( \frac{Q {K}^{T}}{\sqrt{{d}_{k}}} ) V ; \qquad Eq . 5$$

Embodiments of the presently disclosed technology adapt QKV attention to the FHRR VSA domain by replacing the above described scoring process with the FHRR VSA's similarity metric. That is, for each FHRR VSA-symbol in the set of queries and keys, embodiments may calculate the similarity between a given FHRR VSA-symbol and the other FHRR VSA-symbols in the set. This calculation creates a score matrix on the domain [−1, 1]. Embodiments may utilize the matrix multiplication of these scores and the values represented in the complex domain to produce the output of a VSA attention mechanism (see e.g., Eq. 6). This operation may be carried out using only similarity and matrix multiplication, thus avoiding the need for arbitrary scaling and a softmax, which can contribute to improved model efficiency.

$$VSA Attention ( Q , K , V ) = s i m . ( Q , K ) \cdot exp ( i π V ) ; \qquad Eq . 6$$

Self-Attention Architecture: As will be described below, by combining skip connections and attention mechanisms into a single module/architecture, embodiments of the presently disclosed technology can demonstrate a self-attention based architecture adapted for processing FHRR VSA-symbols. Such a self-attention based architecture can provide a powerful, trainable architecture to allow for the mapping of VSA-symbols between domains.

In general, a self-attentional architecture takes a set of inputs distributed over a space—positional, temporal, or otherwise—and uses attention to learn the relevance between information present in different inputs. For instance, an NLP attention model will ‘attend to’ the relevance between words at different positions in a sentence.

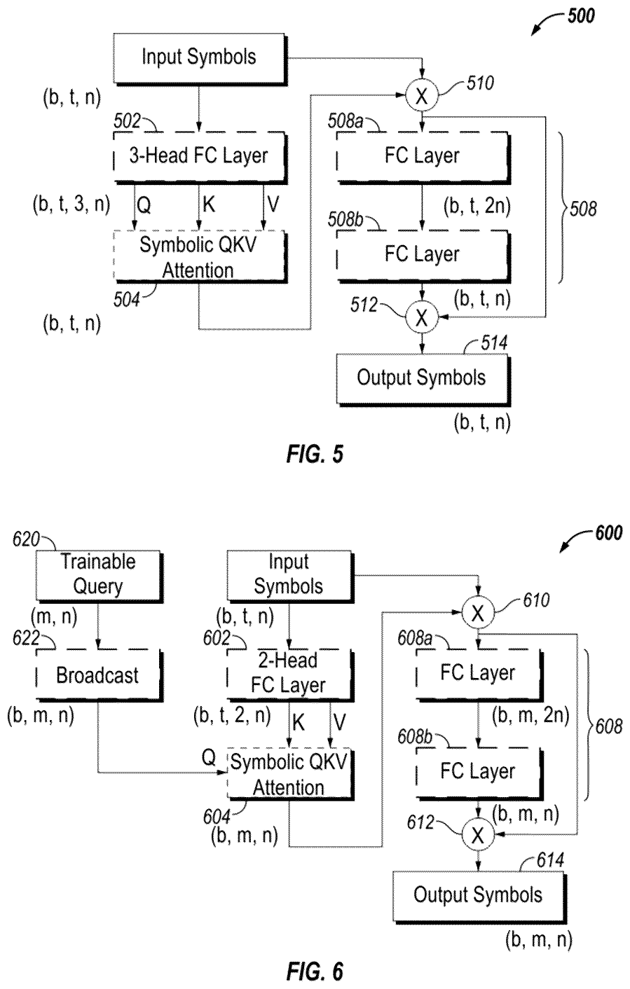

Referring now to FIG. 5, FIG. 5 depicts an example self-attention neural network architecture 500, in accordance with embodiments of the disclosed technology. In various example, self-attention neural network architecture 500 may be implemented using FHRR VSA-symbols. As depicted, self-attention neural network architecture 500 includes 3-head fully-connected neural layer collection 502 (i.e., three side-by-side fully-connected neural layers having an output size of “n”), symbolic QKV attention 504, fully-connected neural layers 508a and 508b (as depicted, these fully-connected neural layers may comprise a residual block 508), and skip connections 510 and 512 (such skip connections may also be referred to as VSA binding operations). As described above, the fully-connected neural layers of self-attention neural network architecture 500 may utilize the generalized bundling function to compute outputs.

To produce a VSA self-attention model (e.g., self-attention neural network architecture 500), embodiments may utilize a stack of three fully-connected neural layers (e.g., 3-head fully-connected neural layer collection 502) with an output size of n (the dimensionality of the VSA-symbols) to convert inputs to query, key, and value symbols. Symbolic QKV attention (e.g., symbolic QKV attention 504) may then be calculated and bound to the original inputs in a (VSA binding-based) skip connection (e.g., skip connection 510). This skip connection may then be followed by a residual block (e.g., residual block 508) with two fully-connected neural layers (e.g., fully-connected neural layers 508a and 508b). The output of this residual block may be bound with its inputs in a second skip connection (e.g., skip connection 512). This second skip connection produces the output of the VSA self-attention model (e.g., output VSA-symbols 514). Here, all neural layers can calculate outputs using the generalized bundling function. Losses through the entire self-attention neural network architecture can be minimized via standard backpropagation.

Cross-Attentional Architecture: While self-attention architectures/modules can theoretically be applied to any number of problems, the scaling of their computational footprint can present challenges. In a self-attention architecture, the score matrix scales with the number of input symbols squared. For large inputs such as those representing ImageNet images, this scaling can prevent challenges for self-attention architectures applied to these problems.

Cross-attention addresses this scaling issue by computing queries and keys/values from different sources. In a cross-attentional architecture/module, keys and values are produced directly from an input, but queries are instead produced from a fixed, trainable set which are known as ‘inducing points.’ This rearrangement still allows for effective training of an attentional network while allowing the computation to scale linearly with the number of inputs.

By modifying the above described VSA self-attention module to produce keys/values from the inputs and queries from a trainable set, embodiments of the presently disclosed technology may construct a symbolic cross-attentional architecture.

Referring now to FIG. 6, FIG. 6 depicts an example cross-attention neural network architecture 600, in accordance with embodiments of the disclosed technology. Cross-attention neural network architecture 600 may be the same/similar as self-attention neural network architecture 500 except in cross-attention neural network architecture 600, query values are not produced from input symbols, but are a set of trainable ‘inducing points.’ In other words, queries for cross-attention neural network architecture 600 are produced from a trainable set via e.g., trainable query 620 and broadcast 622.

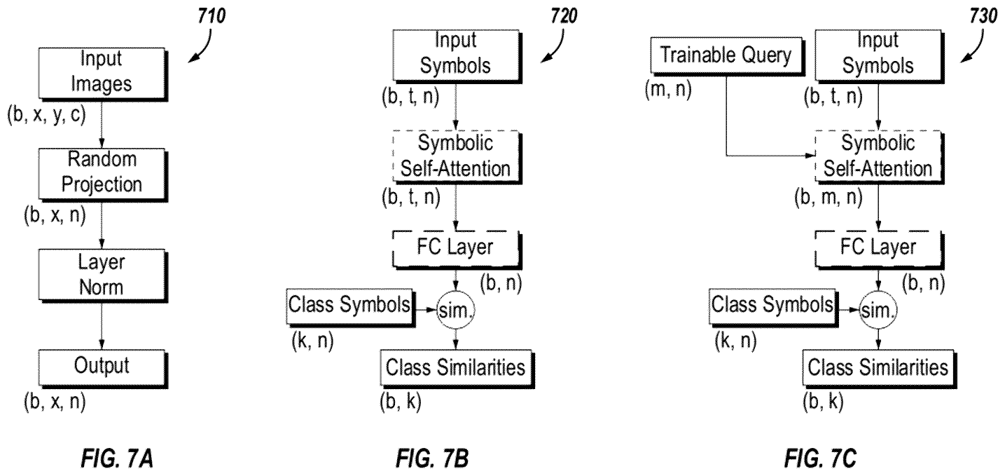

Image Classification: To test and validate the above described approaches on a common task, embodiments can project individual rows of a FashionMNIST image into FHRR VSA-symbols using a Gaussian random projection and Layer Norm (see e.g., diagram 710 of FIG. 7A). A self-attention block may produce another set of FHRR VSA-symbols from these inputs, which can then be reduced via a fully-connected neural layer into a single VSA-symbol (see e.g., diagram 720 of FIG. 7B). This single VSA-symbol may then be compared against a fixed ‘codebook’ which stores class symbols, with each stored class symbol representing one possible class. The class with the highest similarity to the output VSA-symbol can be chosen as the network's class prediction (see e.g., diagram 720 of FIG. 7B).

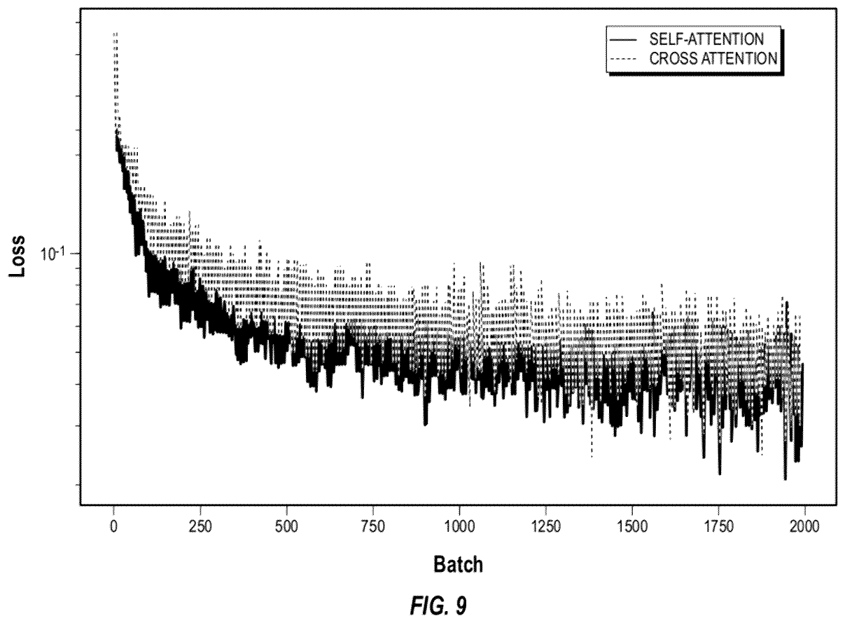

Alternately, a cross-attention block may replace the self-attention block (see e.g., diagram 730 of FIG. 7C). In this case, a set of trainable query values can be used and images may only be applied to produce the key/value inputs to the cross-attention block (see e.g., diagram 730 of FIG. 7C). Otherwise, the architecture may remain the same. For both architectures, training can minimize the distance between the model's output VSA-symbol and its matching class symbol (see e.g., FIG. 9).

To successfully predict a class, the attention module may learn to attend between a set of VSA-symbols, each of which representing a row from the original image. In example experiments, both the self-attentional and cross-attentional architectures learned to do this effectively, reaching classification performance on the test set of 88.6% and 85.5%, respectively.

Drug Toxicity Prediction: While testing on FashionMNIST may validate approaches in accordance with embodiments of the presently disclosed technology on a simple task, it may not leverage the ability of VSAs to compose and represent complex objects or demonstrate that symbolic attentional architectures can address problems in different domains. To address this, embodiments may apply the same attentional architectures used for FashionMNIST classification towards processing molecular structures provided by the CardioTox dataset. This dataset includes characteristics of molecules, such as atoms and bonds. As will be described below, embodiments may use such a dataset to predict whether a molecule can bind with hERG, a protein involved in human heart activity. To do this, embodiments may take a representation of the molecule as a graph and produce a prediction of toxicity with a confidence level.

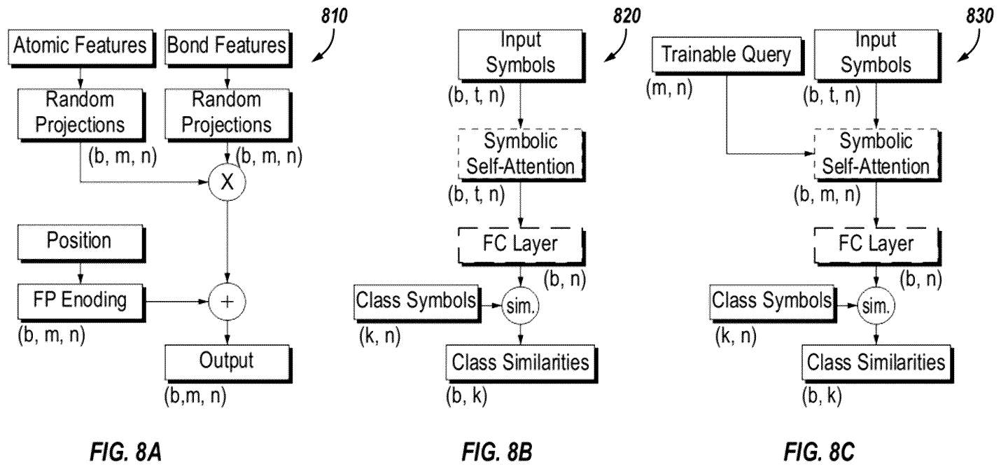

In the CardioTox dataset, each example consists of a molecule described by a graph, where nodes represent atoms and edges represent bonds. Both atoms and bonds contain a number of features. Embodiments may randomly project each atom and bond's features into the FHRR VSA domain to create VSA-symbols representing them. For example, VSA-symbols representing the two atoms involved in a bond and the bond's characteristics can be bound to create a VSA-symbol representing each edge in the graph. These VSA-symbols can then be bundled with a fractional power encoding representing position to create a unique VSA-symbol for each edge in the graph (see e.g., diagram 810 of FIG. 8A). This set of VSA-symbols can be used to represent the molecule whose toxicity is being predicted. This set of VSA-symbols may vary in length according to the number of bonds in the input molecule. Here, the arbitrary structure of a graph representing a molecule can be converted into a single VSA-symbol of constant dimension ‘n’. This can allow it to be processed by the same self and cross-attentional architectures which were previously used to classify images.

To enable batch-based processing, embodiments may pad these inputs with zeros to create a constant shape. Embodiments then may apply the padded inputs as inputs into the same self and cross-attentional networks used for image classification (see e.g., diagrams 820 and 830 of FIGS. 8B and 8C respectively). In certain examples, the codebooks for these models may only have two symbols: ‘toxic’ and ‘non-toxic.’ Each neural network's final output VSA-symbol for each molecule may be compared to this codebook, and the difference in absolute similarities between ‘toxic’ and ‘non-toxic’ can be used as the model's confidence level for classification. Again, training may minimize the distance between the model's output VSA-symbol and the appropriate label symbol.

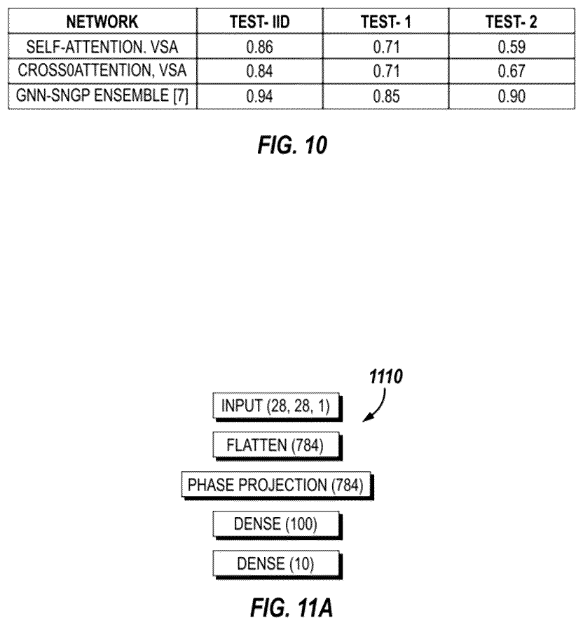

In example experiments, performance on this test set was measured by area under receiving operator characteristic (AUROC) on three test sets. One test set consisted of molecules which were similar to the training set (test-IID), and the other tests consisted of molecules dissimilar to the training set (test-1, test-2). Results from these experiments are summarized in the table depicted in FIG. 10. These models did not reach the level of state-of-the-art models, but also do not require any domain-specific methods and are initial results accomplished using a relatively simple graph encoding.

Discussion: As described above, embodiments of the presently disclosed technology adapt techniques from deep learning to create novel neural network architectures suited for processing distributed, hyperdimensional symbols (i.e., VSA symbols). Embodiments are able to achieve this using a limited set of operations (e.g., matrix multiplication in the complex domain and the FHRR operations of binding, bundling, and similarity) which could conceivably be implemented via neuromorphic hardware. Such an approach can be extended by demonstrating that similarly to multi-layer perceptron models (i.e., spiking equivalents of these attentional architectures) can be executed via the exchange of precisely-timed spikes.

In recent studies the Perceiver IO model has demonstrated that combining self and cross-attentional modules can allow for designing advanced models for a variety of tasks. Key to the Perceiver IO model is the use of a specialized output query which can be constructed to specify tasks, such as optical flow at a given point in a video frame. Embodiments of the presently disclosed technology can potentially replicate the full Perceiver architecture using VSA attention modules and inputs/queries constructed via symbolic operations to firmly establish the parallels between these models and potentially enable their execution via neuromorphic hardware.

Embodiments demonstrate effective methods for implementing residual and attention based neural networks using only operations which are already required to compute within a specific Vector-Symbolic Architecture (VSA), the Fourier Holographic Reduced Representation (FHRR). Accordingly, embodiments may provide novel and powerful methods for converting between different domains of symbolic or real information using operations compatible with hardware designed for VSA-based processing.

Summary of Embodiments: In summary of above, embodiments of the presently disclosed technology provide neural networks (e.g., deep neural networks, self-attention neural networks, cross-attention neural networks, etc.) comprising fully-connected neural network layers (i.e., neural network layers having connections between every input and every output) that utilize generalized bundling functions to progressively transform/process symbols (e.g., FHRR VSA symbols) in order to more efficiently extract useful information from the symbols and/or inputs from which the symbols are derived. Such progressive information extraction can lead to improved problem-solving capabilities for the neural networks (e.g., improved classification accuracy, improved analytical reasoning, etc.).

For example, a neural network of the presently disclosed technology may comprise a fully-connected neural layer that implements a generalized bundling function to transform a first set of symbols into a second set of symbols. As alluded to above, the generalized bundling function may comprise a bundling operation that uses a weight matrix to influence amounts by which individual values of symbols of the first set of symbols contribute to the second set of symbols. Here, the amounts by which the individual values of the symbols of the first set of symbols contribute to the second set of symbols may vary based on the individual values. For example, a first value from a first symbol of the first set of symbols may have a larger contribution to the second set of symbols than a second value of the first symbol of the first set of symbols. As another example, the first value from the first symbol of the first set of symbols may have a larger contribution than a first value from a second symbol of the first set of symbols. It should be understood that such a generalized bundling function is distinct from conventional bundling operations. Namely, conventional bundling operations do not include individual weights. Instead, conventional bundling operations combine all input symbols in an input set equally, irrespective of the input symbols and their constituent values. Relatedly, conventional bundling operations are generally unable to change dimensionality between input symbols and output symbols (in part this is because, unlike the generalized bundling operation of the present technology, conventional bundling operations do not multiply inputs by a weight matrix). By contrast, the generalized bundling function of the presently disclosed technology can change dimensionality between inputs and outputs based on the size of its weight matrix. In other words, in accordance with the weight matrix being a first size, the fully-connected layer transforms the first set of symbols to a different dimensionality in the second set of symbols. By contrast, in accordance with the weight matrix being a second size, the fully-connected layer transforms the first set of symbols to a same dimensionality in the second set of symbols. Accordingly, implementing a generalized bundling function of the present technology can allow a neural layer to perform a more diverse set of operations, including operations that modify dimensionality between an input set of symbols and an output set of symbols.

In some embodiments, the generalized bundling function may further comprise a bias that moves an origin of complex values output from the generalized bundling function from 0+0i to 1+0i. As alluded to above, given this change, the distribution of angular values produced by the generalized bundling function becomes normally centered around zero (see e.g., FIG. 2). With this change, a skip connection operating on the output of the fully-connected neural layer can approximate the identity function. Additionally, embodiments can substitute the VSA ‘binding’ operation on the output of the fully-connected neural layer to replace addition, as the former restricts the output to be on the VSA's domain and allows the computation to remain compatible with neuromorphic hardware which implements VSA operations (as opposed to/instead of arbitrary mathematical operations). Such substitution can produce a residual block which solely employs operations used within the VSA.

In summary, the generalized bundling function describes the manner in which a set of symbols (e.g., a set of FHRR VSA symbols) may be transformed into another set of symbols using linear algebra in the complex domain. The generalized bundling function may comprise a bundling operation that (unlike conventional bundling operations) includes weights which can (a) influence amounts by which individual values in a symbol contribute to one or multiple outputs of the generalized bundling function; and (b) optionally project the outputs to a different dimensionality than the inputs. Accordingly, the generalized bundling function can produce a set of symbols which have an arbitrary number and/or dimensionality (here the dimensionality of a symbol may refer to the number of constituent values of the symbol). The generalized bundling function may contain the same/similar stages used in the construction of a standard neural network layer—e.g., a weighting followed by a continuous non-linear activation function—allowing it to function in a similar manner. This allows for the construction of neural networks augmented by the ability to utilize vector-symbolic techniques.

In various embodiments, the above-described neural network may comprise a residual block (e.g., residual block 308). The residual block may comprise the fully-connected neural layer (e.g., fully-connected neural layer 308a) and a skip connection (e.g., skip connection 308c). Here, the skip connection may comprise a logical block that implements the skip connection. As described above, the fully-connected neural layer may implement the generalized bundling function to transform the first set of symbols into the second set of symbols. The skip connection may bind the first set of symbols with the second set of symbols or a set of symbols derived from the second set of symbols to produce a third set of symbols. In some embodiments, the neural network may further comprise a projection transformation (e.g., a logical block that implements a projection transformation such as random projection transformation 302) that transforms classifiable inputs (e.g., images) into unnormalized symbols (e.g., unnormalized FHRR VSA symbols) representing the classifiable inputs. The neural network may also comprise a normalization transformation (e.g., a logical block that implements a normalization transformation such as layer normalization transformation 304) that normalizes the unnormalized symbols to produce the first set of symbols. In certain embodiments, the neural network may also comprise a similarity operation (e.g., a logical block that implements a similarity operation such as similarity operation 310) that compares the third set of symbols to class symbols represented in a vector space of the third set of symbols (e.g., a FHRR VSA vector space). Such a comparison may yield classification predictions for the first set of symbols (i.e., the input set of symbols), or the classifiable inputs from which the first set of symbols are derived. Such a comparison can also be used to refine the fully-connected neural layer.

In some embodiments, the residual block may further comprise a second fully-connected neural layer (e.g., fully-connected neural layer 308b). The second fully-connected neural layer may implement a second generalized bundling function to transform the second set of symbols (i.e., the outputs from the fully-connected neural layer) into a fourth set of symbols. The second generalized bundling function may comprise a bundling operation that uses a second weight matrix to influence amounts by which individual values of symbols of the second set of symbols contribute to the fourth set of symbols (in other words, the second bundling function may be the same/similar as the first bundling function, except with a different weight matrix). In these embodiments, the skip connection may bind the first set of symbols (i.e., the input into the residual block) with the fourth set of symbols (i.e., the output of the second fully-connected neural layer) to produce the third set of symbols. In some of these embodiments, according to size of the weight matrix (i.e., the weight matrix of the fully-connected neural layer), dimensionality of the second set of symbols (i.e., the output of the fully-connected neural layer) may be double dimensionality of the first set of symbols (i.e., the input into the fully-connected neural layer. By contrast, according to size of the second weight matrix (i.e., the weight matrix of the second fully-connected neural layer), dimensionality of the fourth set of symbols (i.e., the output of the second fully-connected neural layer) may be half the dimensionality of the second set of symbols (i.e., the input of the second fully-connected neural layer). Relatedly, the fully-connected neural layer may be twice as wide as the second fully-connected neural layer. Here, such changes in dimensionality can be used to more effectively and/or efficiently extract useful information from the symbols/inputs and to reduce noise. Likewise, the process of progressively transforming the first set of symbols can be used to extract useful information from the symbols/inputs and to reduce noise.

In various embodiments, the neural network may comprise a self-attention neural network (e.g., self-attention neural network architecture 500). Accordingly, the self-attention neural network may comprise: (1) a three-head fully-connected neural layer collection (e.g., three-head neural network layer 502) that converts the first set of symbols to query, key, and value symbols representing the first set of symbols; (2) a symbolic query-key-value (QKV) attention operation (e.g., a logical block that implements a symbolic QKV attention operation such as symbolic QKV attention 504) that calculates and produces symbolic QKV attention symbols from the query, key, and value symbols output from the three-head fully-connected neural layer collection; (3) a first skip connection (e.g., skip connection 510) that binds the calculated symbolic QKV attention symbols with the first set of symbols to produce a third set of symbols; and (4) a residual block (e.g., residual block 508) comprising a fourth fully-connected neural layer (e.g., fully-connected neural layer 508a) and a second skip connection (e.g., skip connection 512). The three-head fully-connected neural layer collection may comprise: (a) the fully-connected neural layer that implements the generalized bundling function to transform the first set of symbols into the query symbols (here the “second set of symbols” referred to above may comprise the query symbols); (b) a second fully-connected neural layer that implements a second generalized bundling function to transform the first set of symbols into the key symbols; and (c) a third fully-connected neural layer that implements a third generalized bundling function to transform the first set of symbols into the value symbols. As alluded to above, the symbolic query-key-value (QKV) attention operation (e.g., symbolic QKV attention 504) calculates and produces symbolic QKV attention symbols from the query, key, and value symbols output from the three-head fully-connected neural layer collection. Accordingly, the first skip connection (e.g., skip connection 510) may bind the calculated symbolic QKV attention symbols with the first set of symbols to produce the third set of symbols. As alluded to above, the residual block (e.g., residual block 508) may comprise the fourth fully-connected neural layer (e.g., fully-connected neural layer 508a) and the second skip connection (e.g., skip connection 512). The fourth fully-connected neural layer may implement a fourth generalized bundling function that transforms the third set of symbols (i.e., the input into the residual block) into a fourth set of symbols. The second skip connection may then bind the third set of symbols with the fourth set of symbols or a set of symbols derived from the fourth set of symbols to produce a fifth set of symbols. In various embodiments, the residual block may further comprise a fifth fully-connected neural layer (e.g., fully-connected neural layer 508b). The fifth fully-connected neural layer may transform the fourth set of symbols (i.e., the output of the fourth fully-connected neural layer) into a sixth set of symbols. In these embodiments, the second skip connection may bind the third set of symbols (i.e., the input into the residual block) with the sixth set of symbols (i.e., the output of the fifth fully-connected neural layer) to produce the fifth set of symbols (i.e., the output of the residual block). As alluded to above, in certain embodiments the first set of symbols may comprise FHRR VSA symbols. Accordingly, the self-attention neural network may further comprise (1) a projection transformation that transforms classifiable inputs into unnormalized FHRR VSA symbols representing the classifiable inputs; and (2) a normalization transformation that normalizes the unnormalized FHRR VSA symbols to produce the first set of FHRR VSA symbols.

In some embodiments, the neural network may comprise a cross-attention neural network (e.g., cross-attention neural network architecture 600). The cross-attention neural network may comprise: (1) a trainable query operation (e.g., a logical block which implements a trainable query operation such as trainable query 620) that produces query symbols from a set of trainable symbols; (2) a two-head fully-connected neural layer collection (e.g., two-headed fully-connected neural layer collection 602) that converts the first set of symbols to key and value symbols representing the first set of symbols; (3) a symbolic query-key-value (QKV) attention operation (e.g., symbolic QKV attention 604) that calculates and produces symbolic QKV attention symbols from the query symbols output from the trainable query operation and the key and value symbols output from the two-head fully-connected neural layer collection; (4) a first skip connection (e.g., skip connection 610) that binds the calculated symbolic QKV attention symbols with the first set of symbols to produce a third set of symbols; and (5) a residual block (e.g., residual block 608) comprising a third fully-connected neural layer (e.g., fully-connected neural layer 608a) and a second skip connection (e.g., skip connection 612). The two-head fully-connected neural layer collection may comprise: (a) the fully-connected neural layer that implements the generalized bundling function to transform the first set of symbols into the key symbols (here the “second set of symbols” referred to above may comprise the key symbols); and (b) a second fully-connected neural layer that implements a second generalized bundling function to transform the first set of symbols into the value symbols. As alluded to above, the symbolic QKV attention operation calculates and produces symbolic QKV attention symbols from the query symbols output from the trainable query operation and the key and value symbols output from the two-head fully-connected neural layer collection. Accordingly, the first skip operation binds the calculated symbolic QKV attention symbols with the first set of symbols to produce the third set of symbols. The third set of symbols may be input into the residual block. As alluded to above, the residual block may comprise the third fully-connected neural layer and the second skip connection. The third fully-connected neural layer may implement a third generalized bundling function that transforms the third set of symbols (i.e., the input into the residual block) into a fourth set of symbols. The second skip connection may bind the third set of symbols (i.e., the input into the residual block) with the fourth set of symbols (i.e., the output of the third fully-connected neural layer) or a set of symbols derived from the fourth set of symbols (e.g., an output of a fully-connected neural layer of the residual block following the third fully-connected neural layer) to produce a fifth set of symbols.

### Supplemental Disclosure

Efficient learning and inference processes remain a challenge for deep-learning based artificial intelligence methods. This may include poor generalization beyond properties of the training data, catastrophic forgetting, lack of transfer of knowledge, etc. Many efforts focus on addressing these challenged by carrying out deep learning via the use of networks which communicate via binary events—‘spikes,’ bringing artificial neurons closer to their highly efficient biological counterparts. While recent efforts to link traditional deep neural networks (DNNs) to spiking neural networks (SNNs) via the usage of rate-coding have yielded SNNs which can attain high accuracy, this achievement comes with several caveats. For example, converting a suitable DNN to a rate-based SNN can require complex conversion methods to normalize weights and activation values. As another example, the resulting spike-based networks lack many established characteristics of biological computation, such as fast inference and sensitivity to the timing of individual spikes. As a third example, even when executing on specialized neuromorphic hardware, these spiking networks provide at best a marginal gain in energy efficiency when compared to traditional networks running on conventional hardware. For these reasons, to create a spiking network which can achieve the goals of neuromorphic computing (such as high performance, energy efficiency, and biological relevance), alternate approaches from rate-coding will likely be required.

Embodiments of the presently disclosed technology can build from previous works that assumes the value of a neuron corresponds to the angle of a complex number, commonly referred to as a “phasor.” Phasors are often used in electrical engineering and physics to provide convenient representations and manipulations of sinusoidal signals with a common frequency. A phasor describes a sinusoidal signal's phase offset relative to a reference signal, and can be scaled by a real magnitude to describe any complex number in polar form (see e.g., Eq. 7).

$$A ∠ φ = {Ae}^{i ω t + φ} = cos ( ω t + φ ) + i sin ( ω t + φ ) ; \qquad Eq . 7$$

Any set of sinusoidal signals with a common frequency can be represented by a vector of phasors, and as their superposition produces another sinusoid, it can also be represented by a single new phasor. This value can be calculated by summing the original vector of phasors in their complex form. The phase of the resulting complex number can be calculated via a non-linear trigonometric operation, allowing the superposition of phasors to form the basis of a neuronal activation function suitable for a deep neural network. The representation of information through phasors and non-linear properties of their superpositions can provide the basis of information processing within phasor networks.

Atemporal Evaluation—Activation Function: The input to a single neuron consists of a vector of phases, x. For convenience and ease of integration within existing deep learning frameworks, embodiments may normalize all phase angles by π, so that x∈[−1, 1]. Multiplying these values by π converts to a standard angle in radians.

To compute a neuron's output given a vector x with n elements, the real valued phases x may be converted into an explicit complex representation (see e.g., Eq. 7). Each complex element may then be scaled by a corresponding weight w, which may be restricted to be entirely real-valued. The sum of the scaled complex elements produces a new complex value with an amplitude and phase. To extract only its phase, the two-argument arctangent (a tan 2) can be applied. Through these operations, a nonlinear neuronal operation may be obtained see (e.g., Eq. 8 below). Additionally, the local continuity of these operations ensures deep networks employing them can be optimized using standard backpropagation techniques.

$$y = \frac{1}{π} \cdot a tan 2 [ {\sum }_{i = 1}^{n} {w}_{i} \cdot {e}^{i π {x}_{i}} ] ; \qquad Eq . 8$$

Atemporal Evaluation—Output and Loss Functions: An important property of harmonic waves propagating with the same frequency is that even when observed at different instants of time, the differences between phases remains constant. This property leads to phenomena such as interference patterns. Here, embodiments can leverage this property to train and evaluate phasor networks without regard to the variable t in Eq. 7. In certain embodiments, phasor networks may not be trained to produce an absolute series of exact phases (as the measurement of a phase is variable with time) but instead to produce constant phase differences (which remain immutable with time).

For instance, for the purposes of a standard classification task, the desired output of a phasor network can be to set one output neuron to be 90° out-of-phase with the rest of the n_{c} neurons in the output layer (see e.g., Eq. 9 below). A single neuron producing an out-of-phase signal may indicate that it is the predicted class of the input image. A simple loss function using cosine similarity to this target can be used to measure the convergence of the network's output to the desired phase differences (see e.g., Eq. 10 below).

$${φ}_{y} = \frac{1}{2} \cdot onehot ( y , {n}_{c} ) ; \qquad Eq . 9$$

$$loss ( y , \hat{y} ) = 1 - cos [ π \cdot ( y - \hat{y} ) ; \qquad Eq . 10$$

Atemporal Evaluation—Image-to-Phase Conversion: One issue in implementing phasor-based networks arises at the input layer of such a network. Inputs such as images are often encoded on a domain with pixel intensities normalized between 0 and 1. As previously stated, a phasor network utilizes inputs on the domain [−1.1]. An initial conversion step between domains can assist phasor networks in reaching performance levels that match conventional networks. Accordingly, embodiments may utilize two intensity-to-phase conversion methods. The first conversion method randomly projects the input pixels, batch-normalizes the output values, and clips them within the domain [−1, 1]. The second conversion method chooses random input pixels to produce either a negative or positive phase. These conversion methods may be referred to as normalized random projection (NRP) and random pixel phase (RPP), respectively.

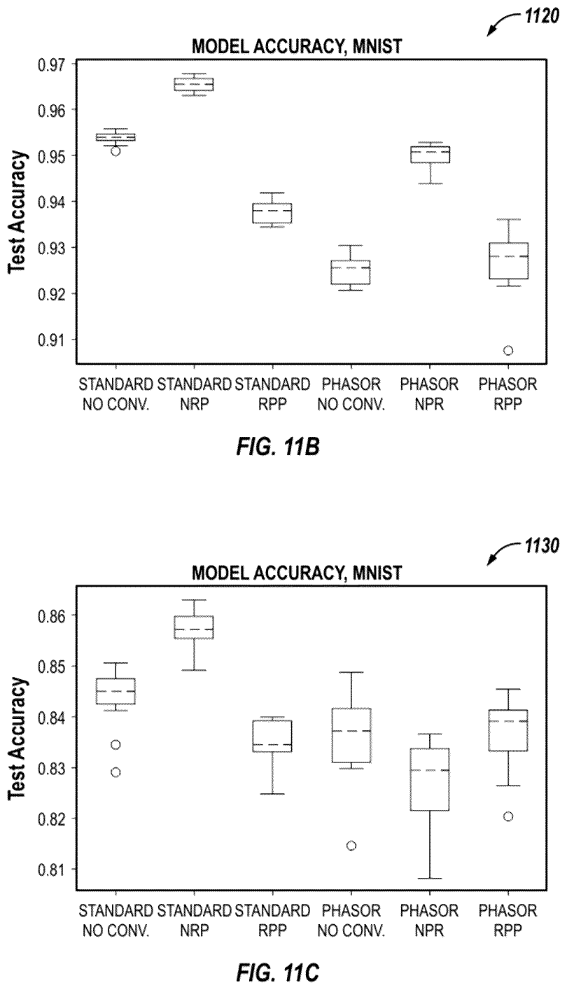

Atemporal Evaluation—Model Architecture and Accuracy: To show that deep phasor networks can be effectively trained using the above described approaches, embodiments can train a series of standard and phasor-based image classifiers on the standard MNIST and FashionMNIST datasets. The architectures of the networks may be identical, consisting of an input layer, intensity-to-phase conversion method, a hidden layer of 100 neurons, and an output layer of 10 neurons. A neuronal dropout rate of 25% can be used for regularization. In the standard networks, a ReLU activation function may be used. In examples experiments conducted in accordance with embodiments, groups of 12 models were trained and the group's mean accuracy plus or minus its standard deviation was reported (see e.g., FIGS. 11A-11C).

In the examples experiments, with an NRP conversion, the standard models reached an accuracy of 96.4±0.1% on standard MNIST after 2 epochs of training. Similarly, the phasor models reached a median accuracy of 95.0±0.3%. Training instead on FashionMNIST dataset, the standard models with NRP conversion reached 85.7+0.4% accuracy on the test set. The highest-performing phasor networks for FashionMNIST instead used the RPP conversion, with an accuracy of 83.7±0.7% (see e.g., FIGS. 11A-11C).

These results can demonstrate that applying phasor-based representation and using the phasor neuron described in Eq. 8 can create networks which can achieve results on-par with standard networks, though Phasor networks underperformed their corresponding standard network by a point or two in accuracy. However, improved image-phase conversion methods or different target labels may assist in closing this small performance gap, which also appears to depend on the dataset.

Temporal Evaluation—Equivalent Resonate and Fire Model: A key advantage of a phasor neuron is that its computations can be carried out approximately in the temporal domain, when all information is not known a priori but instead arrives to the network at different times and in the form of binary spikes. Taking the derivative of a complex number z representing a harmonic signal with respect to time (see e.g., Eq. 11), Eq. 12 can be obtained, which may be identical to the case of a resonate and fire (R&F) neuron with no ‘leakage’ (attraction to the rest state). Leakage can be re-introduced to show that the dynamics of the R&F neuron are innately linked to the activation function forming the basis of inference in a phasor network. In the model of an R&F neuron with no leakage, the voltage-current oscillation produced after a current pulse may be identical to the rotation of a phasor represented in Eq. 11. Following the original R&F convention, the ‘current’ U of an R&F neuron may be referred to as the real part of its complex potential z, and its ‘voltage’ V as the imaginary part of z.

$$z = A {e}^{i ω t + φ} ; \qquad Eq . 11$$

$$\frac{\partial z}{\partial t} = ( 0 + i ω ) z \to ( - b + i ω ) z ; \qquad Eq . 12$$

The superposition and phase detection which was previously calculated atemporally using Eq. 8 can be carried out in the temporal domain using an R&F neuron with no leakage. First, the duration of one cycle of time in the system may be defined as T, giving the neuron a natural angular frequency ω of 2π/T. Input phases in a vector x with n elements can be represented by Dirac delta functions which occur once per cycle, offset from the temporal midpoint of the period proportionally to their value. Real-valued weights can be represented again with w (see e.g., Eq. 13 below).

$$\frac{\partial z}{\partial t} = i ω z + {\sum }_{i = 1}^{n} {w}_{i} δ ( t - {x}_{i} ) ; \qquad Eq . 13$$

$$z ( T ) = {\int }_{t = 0}^{t = 2} \frac{\partial z}{\partial t} = {\sum }_{i = 1}^{n} {e}^{- i π x} if z ( 0 ) = 0 ; \qquad Eq . 14$$

Integrating Eq. 13 through a single cycle T (t=0 to 2) produces another form of the superposition of complex values (Eq. 14, proof in methods). The timing of the inputs x produces the phase of the output z, which can be detected after the integration period by determining the time when two conditions (such as V>0 and ∂V/∂t=0) are met. This allows the full calculation required for a Phasor neuron (complex superposition & phase measurement) to be carried out in the temporal domain using input spikes.

However, leakage should be retained within R&F neurons if they are to carry out different computations through time (allowing their potentials to gradually return to the initial condition required in Eq. 14). By gradually increasing the level of leakage b in the R&F neuron from 0, the same approximate calculation can be carried out without having a major effect on the phase of the superposition, though the leakage should stay above several periods of the natural frequency. The representation of inputs by an ideal Dirac delta function can also be relaxed by convolving it with a kernel such as a box function (Π(t) with width scale factor s). These alterations (leakage and box kernel) are included in example Eq. 15, which can be solved numerically through time to calculate the current and voltage of a Phasor neuron.

$$\frac{\partial z}{\partial t} = ( - \frac{T}{b} + \frac{i 2 π}{T} ) Z + {\sum }_{i = 1}^{n} {w}_{i} \prod ( s \cdot t - {x}_{i} ) ; \qquad Eq . 15$$

To produce a series of output spikes from an R&F neuron, its threshold function may be defined. To meet the requirements of a phasor network, a spike can be produced from the R&F neuron when it reaches a certain phase of its current/voltage oscillation. This phase can be found by determining when the neuron's complex potential sweeps through a defined set of conditions. Embodiments may define a neuron's phase as reaching ½ the moment when its imaginary value reaches a maximum (∂Im(Z)/∂t=0 and Im(Z)>0) and produce a spike only at this phase. Additionally, to produce an output spike the voltage should be above a set threshold (Im(Z)>t), and a short refractory period (T/4) afterward can reduce the occurrence of multiple spikes in the same period. This gradient-based method can allow the output spikes to be sparsely produced without referencing an external clock. For conciseness and given their approximate equivalence, embodiments may term an R&F neuron using this spike detection method a temporal phasor neuron.

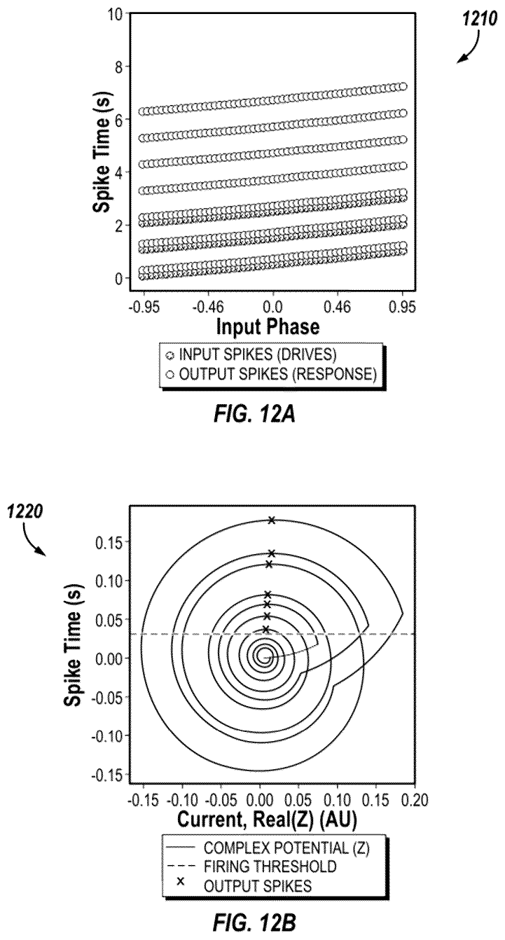

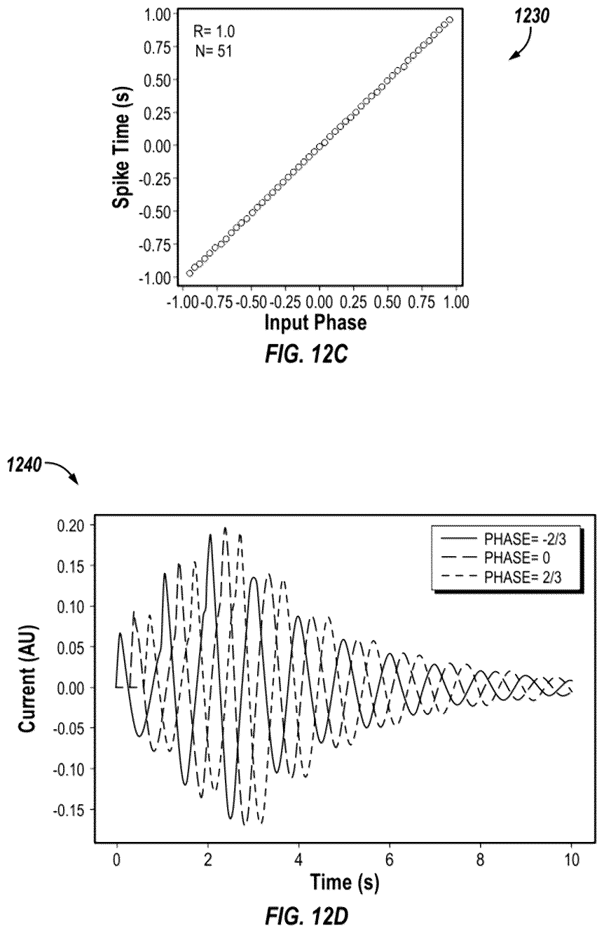

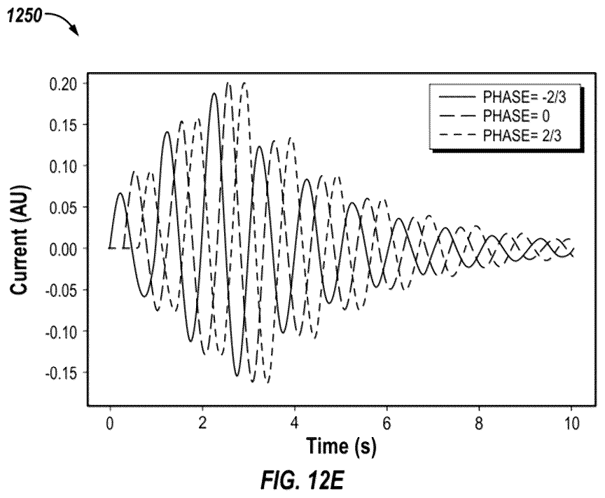

Temporal Evaluation—Demonstration of Equivalent Neuron: Embodiments can demonstrate a temporal phasor neuron carrying out the identity function. Here, given an input consisting of binary spikes repeating at its eigenfrequency, a phasor neuron may resonate with this stimulus to produce another series of output spikes (see e.g., diagrams 1210-1220 and 1240-1250 of FIG. 12). To communicate the phase of an input, these spikes can be offset from the center of an interval relative to their value (e.g. if x=[−1, 0, 1], 0, and T=1, t=[0, ½, 1], [1, 3/2, 2], . . . ).

Each stage of integration may produce a quarter-period of delay (¼T) relative to its input. Adding this delay relative to the absolute time reference of the network's starting point, the phases of the output spikes can be decoded and compared to the ideal values encoded within the input spike trains. These decoded output phases can successfully recover the values encoded in the input (see e.g., diagram 1230 of FIG. 12). These result may demonstrate that the complex summation and phase-detection can succeed at integrating and reproducing a single input.

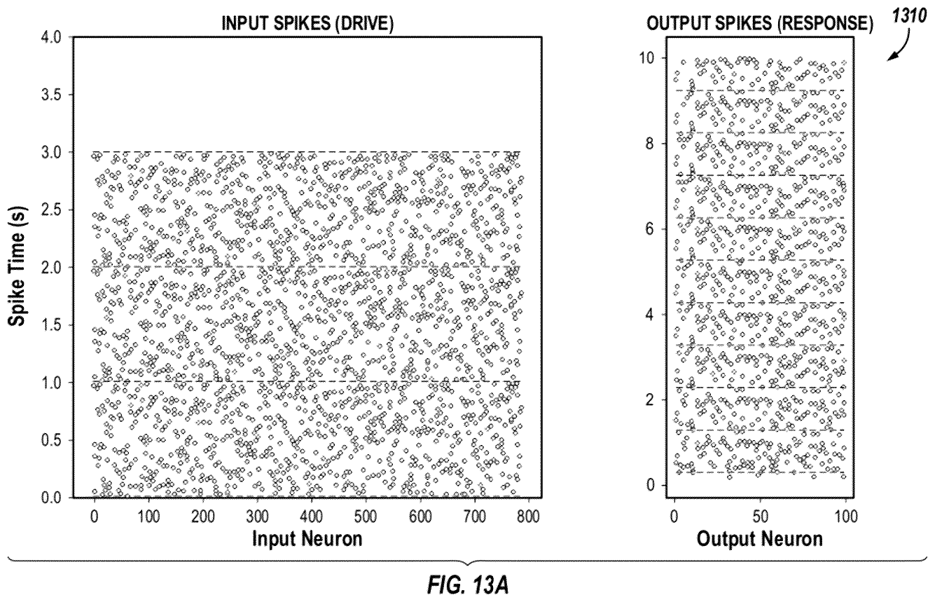

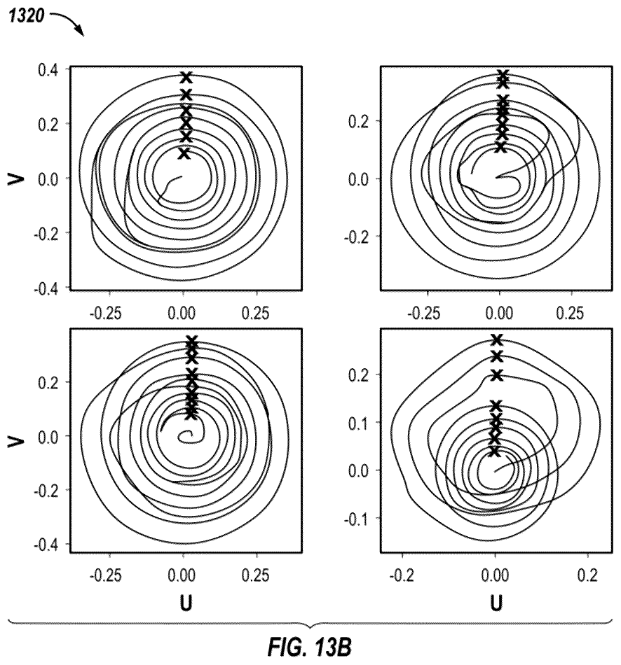

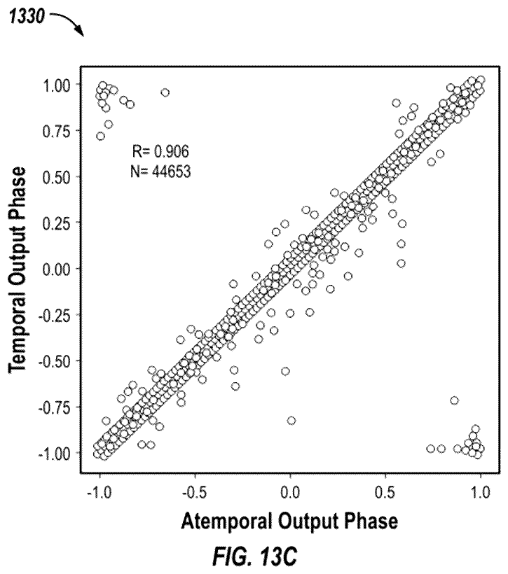

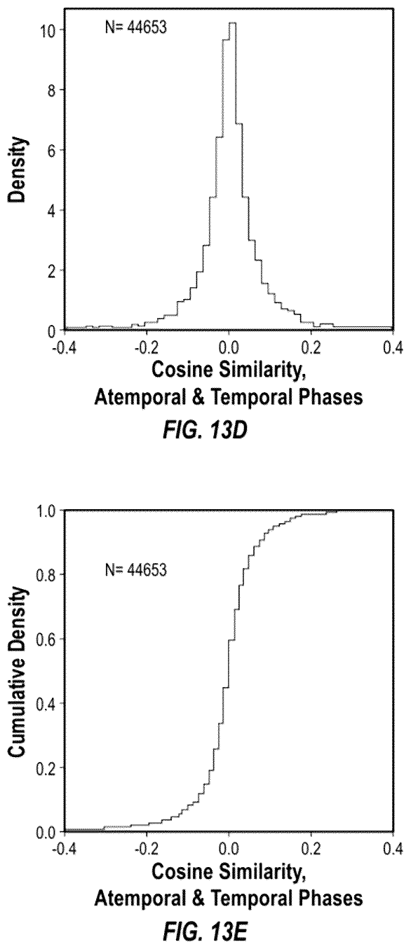

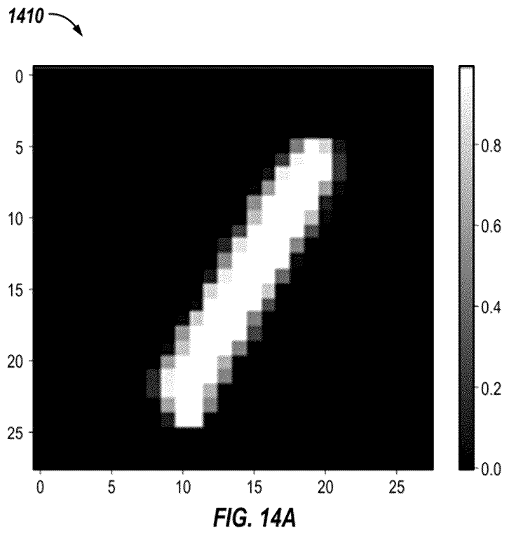

Temporal Evaluation—Demonstration of Equivalent Layer: To demonstrate that a temporal phasor neuron can also calculate an approximately correct superposition of its inputs (as described in Eq. 15), embodiments can create a series of neurons corresponding to a ‘layer’ in a conventional network. The input weights to this temporal layer may be identical to those found in an atemporal Phasor network after it is trained on the standard MNIST dataset. A series of stimuli consisting of random phases applied to each neuron may be constructed and evaluated using the atemporal and temporal methods. The conversions between spikes and phases at the layer inputs and outputs may be the same as previously described. However, as each neuron operating temporally is now subject to impulses from multiple (784) sources, it should accurately integrate the weighted sum of these inputs to produce a correctly-timed output spike (see e.g., diagrams 1310 and 1320 of FIG. 13).

In various examples, the approximations used to produce Eq. 15 may not prevent a temporal Phasor neuron from producing a value which is highly related to its desired value (R=0.91 through all periods) and often calculates it with little error (see e.g., diagrams 1330-1350 of FIG. 13). This may demonstrate that a temporally-executed layer of Phasor neurons can produce a very good approximation of its atemporal counterpart.

Temporal Evaluation—Demonstration of Equivalent Network: Given the approximate equivalence of a phasor layer executing via spikes in the temporal domain, the performance of a full model used for image classification (detailed above) can also be investigated. The structure and weights of this network may remain unchanged—and the network may be trained via standard backpropagation during atemporal execution. The resulting weights can be directly used to execute the network temporally. The predicted output class of an image may be decoded from the output spike train by detecting its phase with reference to the starting time and finding the neuron with the phase closest to the target value of ½.

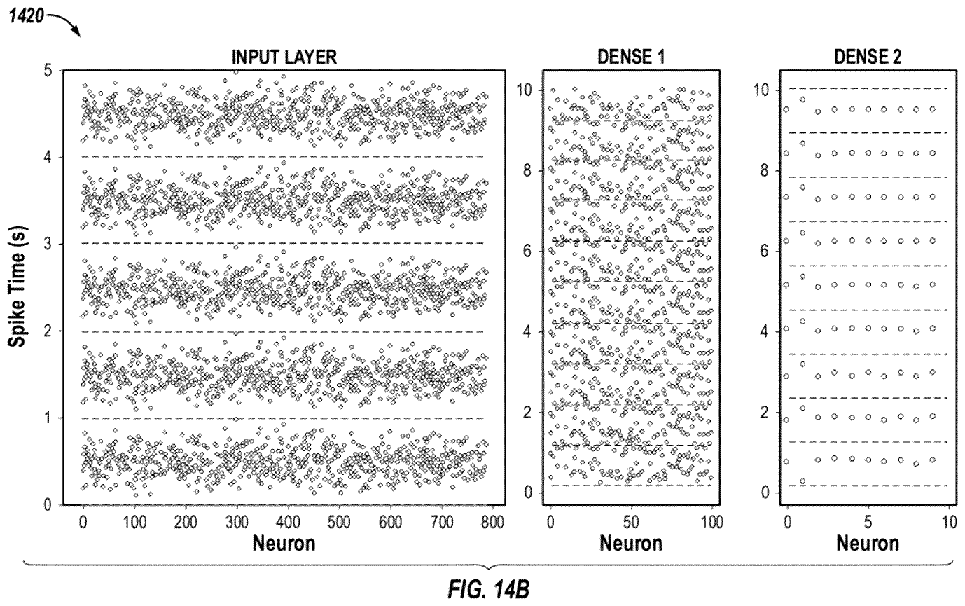

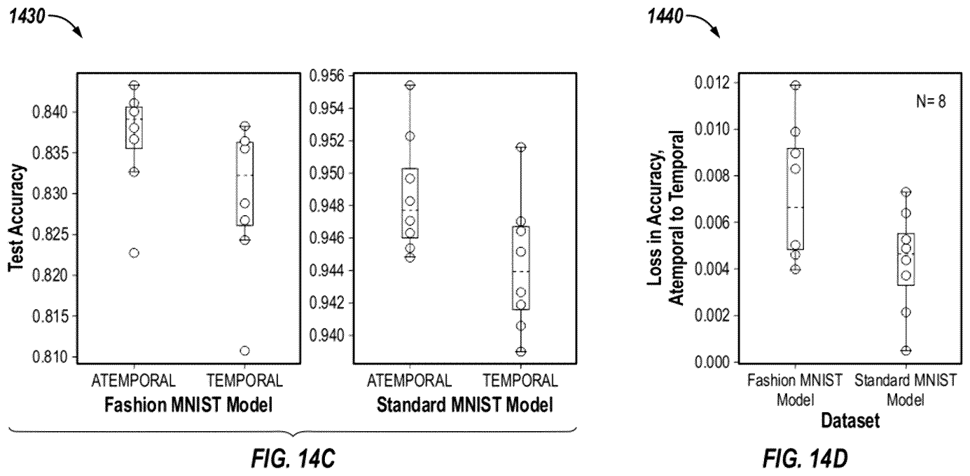

Despite the significant change in underlying execution strategy—from standard matrix multiplication and activation function to the integration of spike-driven currents and phase detection through time—the final accuracy of the network may differ little. After an input image is flattened and goes through the phase conversion into spikes, each spiking layer of the network can perform an integration through time with sufficiently high accuracy to produce the desired output (see e.g., diagrams 1410 and 1420 of FIG. 14). In example experiments, results from 2 sets of 8 networks trained on the standard MNIST or Fashion MNIST datasets showed that results from the two execution modes were so similar that on average, only 0.57% accuracy was lost by switching from atemporal to temporal execution (see e.g., diagrams 1430 and 1440 of FIG. 14).

General Discussion: To summarize, embodiments of the presently disclosed technology may demonstrate that the activation function of a standard neural network can be replaced by one which is produced through the interaction of complex numbers representing phases. Using this modified activation function, each neuron in the network can be thought of as integrating the phases of a set of inputs to produce a new output phase. If all inputs are known ahead of time and with high precision, this calculation can be done in a time-agnostic or ‘atemporal’ manner. However, if all inputs are not known ahead of time, the calculation can also be carried out in real-time, integrating the signals as they arrive to produce a dynamic, time-varying calculation. The latter case may be closer to current understandings of biological computation, and furthermore, inter-neuron communication may be carried out using spikes. Accordingly, embodiments can bring deep learning closer to biological relevance while maintaining key advantages over other spike-based deep learning models and provides a basis for future research.

General Discussion—Execution: One of these advantages of phasor representation is its ability to present the network with a complete input within a set time interval defined by the neuron's resonant frequency; each phase may be encoded by its offset within this interval, not the accumulated rate of spikes as is the case in rate-coding. This allows the network to produce outputs quickly (as shown in diagram 1420 of FIG. 14) and on an established time basis rather than waiting an arbitrarily defined amount of time. Additionally, the constant dynamic coupling between layers can transmit information through the network with small delays, although this may be quantified with testing on deeper models. In various embodiments, latency characteristics may be tested as well as the performance of phasor networks in modern, deep networks with real-world applications such as image detectors.

An argument which can be presented against phasor networks is that they trade off the long integration times of rate-based networks by instead using a continuous time domain which may consist of an equivalent or even greater number of discrete steps when calculated on digital, clocked hardware. This point may be addressed by embodiments by examining in more depth the effect of time and weight quantization on the execution of phasor networks. However, even if using an equivalent number of time steps, phase-based encoding maintains the advantage that only one spike is required per integration period and all values are encoded with an equal amount of error, in contrast to rate-based coding which may require many spikes and encodes different values with different amounts of uncertainty.

Furthermore, the oscillatory behavior inherent in the temporal behavior of a Phasor neuron offers the possibility that it could be implemented efficiently via a variety of novel analog hardware devices specifically designed to carry out computations via coupled oscillators. These devices can exploit the natural dynamics of electrical or mechanical oscillations to compute with extremely high efficiency. Combining these two approaches could therefore offer a potential application for these emerging systems by providing a framework for executing traditional AI methods with high efficiency via coupled oscillations.

Pathways also exist to implement Phasor networks on currently available neuromorphic hardware, many of which use integrate-and-fire rather than resonate-and-fire or more complex models. However, certain previous works have demonstrated how resonate-and-fire networks can be implemented via network dynamics with integrate-and-fire neurons, providing a method to extend Phasor networks to execute via alternative neuronal dynamics.

General Discussion—Training & Architecture: Another challenge of neuromorphic, spike-based architectures can be the problem of how they can be efficiently trained in-situ, rather than exist solely as inference-only conversions of conventional networks trained via standard backpropagation on traditional hardware. This complex challenge consists of multiple issues, both practical and theoretical. Two such issues include backpropagating errors through binary spikes and the high memory requirements of training methods (such as backpropagation through time (BPTT)) which address the recurrent, temporal nature of spiking networks.

The use of surrogate gradients to produce eligibility traces on synapses allows synaptic variables to be included as a part of a dynamical system solved forward through time, allowing an observer in the future to approximately infer how recent spikes contributed to the current neuronal state and assign error credit. But rather than using BPTT to solve credit assignment with a phasor network, its continuous update may allow instead for adjoint sensitivity methods to solve the coupled system backwards in time for a short period of time. This may greatly reduce the memory requirements of assigning credit through time, potentially creating an efficient method for training phasor networks inherently in the temporal domain. Various embodiments can also investigate the application of synaptic plasticity, local learning rules, and feedback alignment in phasor networks to avoid the more theoretical concerns of gradient and weight transport.

The fundamental representation of information via phase values in embodiments of the presently disclosed technology can provide a rich basis of computation which can allow future phasor networks to compute with radically different architectures than traditional networks. This may be due to the fact that a vector of phase values as used in embodiments is identical to the basis of information in a vector-symbolic architecture, the Fourier Holographic Reduced Representation (FHRR). This enables vectors produced by each layer of a phasor network to be manipulated through vector-symbolic manipulations such as binding and bundling, allowing rich data structures to be built within the framework of the network's evaluation. These operations can be used to build radically different computation architectures with capabilities such as the factorization of components into symbols, linking them to the emerging field of neurosymbolic computation while maintaining spike-compatible computation.

Conclusion: Embodiments of the presently disclosed technology may demonstrate that by replacing the activation function of a standard feed-forward network by one created via complex operations, a novel ‘phasor’ network is created which can be executed either temporally or atemporally with no conversion process and only slight differences in output. The spiking and oscillatory computations of the temporal Phasor network can have strong parallels to biological computation, can be adapted to current or future neuromorphic hardware, and provide a rich basis for the construction of novel training methods and architectures.

Referring now to the FIGs. described above, FIGS. 11A-11C depict a series of diagrams and graphs. Diagram 1110 depicts an example deep phasor network architecture, in accordance with embodiments of the presently disclosed technology. Classification accuracy of this deep phasor network architecture on the standard MNIST dataset is illustrated in graph 1120. Classification accuracy of this deep phasor network architecture on the standard FashionMNIST dataset is illustrated in graph 1130. As described above, ‘standard’ models use a ReLU activation function while ‘Phasor’ models use the phasor activation method described above. NRP models apply a normalized random projection to convert intensities to phases and RPP models randomly select pixels to produce positive or negative phases.

FIGS. 12A-12E depict a series of graphs, in accordance with various embodiments of the present disclosure. As depicted by graph 1210, a Phasor neuron may be stimulated by an input spike train with different phases relative to the absolute stat time t=0 s. Graph 1220 depicts the arrival of impulses spaced at the Phasor neuron's eigenfrequency that cause the Phasor neuron to resonate as it integrates the current resulting from the spike, firing once a cycle when it reaches its maximum voltage level. As depicted by graph 1230, the phase of the Phasor neuron's output spikes can be decoded using the initial starting time plus an integration delay (0.25 s). These decoded phases can match the input phases to a high degree of precision. The difference in dynamics created by phase offsets can be clearly seen here by comparing the currents (depicted in graph 1240) and voltages (depicted in graph 1250) of a Phasor neuron.

FIGS. 13A-13E depict a series of graphs, in accordance with various embodiments of the present disclosure. As depicted by diagram 1310, a spike raster shows 1 set of 64 inputs which stimulate a layer of Phasor neurons, which produce a series of spikes in response. Horizontal lines demarcate the boundaries between integration periods. As depicted by graph 1320, phase portraits of individual Phasor neurons being driven can show their integration of multiple inputs into a complex value which evolves with time and produces an output spike at a single phase. All current (U) and voltage (V) values may have arbitrary units. Graph 1330 depicts how high correlation may be observed between the spike phases decoded from the temporal network using an absolute time reference and the ideal values produced by the atemporal network. Graphs 1340 and 1350 may depict the cosine similarity between the temporal and atemporal phases and illustrate the error produced by the temporal evaluation. These errors are generally small and appear normally-distributed.

FIGS. 14A-14D depicts a series of images and graphs, in accordance with various embodiments of the present disclosure. Image 1410 depicts an input image from the MNIST dataset of the digit ‘1’. Graph 1420 depicts how that image may be (1) converted from intensities to phases and (2) into a spike train which drives the phasor network in the temporal domain. Horizontal lines demarcate the boundaries between integration periods. The network may be trained to produce an out-of-phase spike on the image label (1). Graph 1430 depicts results from example experiments where 2 sets of 8 networks were trained on the MNIST and FashionMNIST datasets. Performances was evaluated in both their atemporal and temporal execution methods, and the resulting accuracies on the test set were reported. Graph 1440 depicts further results from the example experiments. As depicted, running in temporal evaluation mode, most models lost an average of only 0.57% accuracy compared to atemporal evaluation.

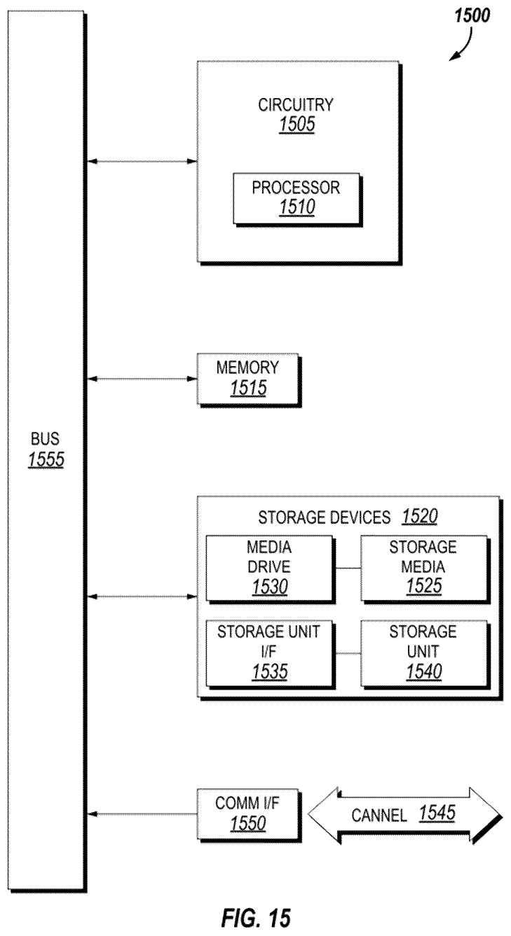

FIG. 15 illustrates example computing component 1100, which may in some instances include a processor on a computer system (e.g., control circuit). Computing component 1100 may be used to implement various features and/or functionality of embodiments of the systems, devices, and methods disclosed herein. With regard to the above-described embodiments set forth herein in the context of systems, devices, and methods described with reference to FIGS. 1-14, including embodiments involving the control circuit, one of skill in the art will appreciate additional variations and details regarding the functionality of these embodiments that may be carried out by computing component 1500. In this connection, it will also be appreciated by one of skill in the art upon studying the present disclosure that features and aspects of the various embodiments (e.g., systems) described herein may be implemented with respected to other embodiments (e.g., methods) described herein without departing from the spirit of the disclosure.

As used herein, the term component may describe a given unit of functionality that may be performed in accordance with one or more embodiments of the present application. As used herein, a component may be implemented utilizing any form of hardware, software, or a combination thereof. For example, one or more processors, controllers, ASICS, PLAS, PALs, CPLDs, FPGAs, logical components, software routines, or other mechanisms may be implemented to make up a component. In implementation, the various components described herein may be implemented as discrete components or the functions and features described may be shared in part or in total among one or more components. In other words, as would be apparent to one of ordinary skill in the art after reading this description, the various features and functionality described herein may be implemented in any given application and may be implemented in one or more separate or shared components in various combinations and permutations. Even though various features or elements of functionality may be individually described or claimed as separate components, one of ordinary skill in the art will understand upon studying the present disclosure that these features and functionality may be shared among one or more common software and hardware elements, and such description shall not require or imply that separate hardware or software components are used to implement such features or functionality.

Where components or components of the application are implemented in whole or in part using software, in embodiments, these software elements may be implemented to operate with a computing or processing component capable of carrying out the functionality described with respect thereto. One such example computing component is shown in FIG. 15. Various embodiments are described in terms of example computing component 1500. After reading this description, it will become apparent to a person skilled in the relevant art how to implement example configurations described herein using other computing components or architectures.

Referring now to FIG. 15, computing component 1500 may represent, for example, computing or processing capabilities found within mainframes, supercomputers, workstations or servers; desktop, laptop, notebook, or tablet computers; hand-held computing devices (tablets, PDA's, smartphones, cell phones, palmtops, etc.); or the like, depending on the application and/or environment for which computing component 1500 is specifically purposed.

Computing component 1500 may include, for example, one or more processors, controllers, control components, or other processing devices, such as a processor 1510, and such as may be included in 1505. Processor 1510 may be implemented using a special-purpose processing engine such as, for example, a microprocessor, controller, or other control logic. In the illustrated example, processor 1510 is connected to bus 1555 by way of 1505, although any communication medium may be used to facilitate interaction with other components of computing component 1500 or to communicate externally.

Computing component 1500 may also include one or more memory components, simply referred to herein as main memory 1515. For example, random access memory (RAM) or other dynamic memory may be used for storing information and instructions to be executed by processor 1510 or 1505. Main memory 1515 may also be used for storing temporary variables or other intermediate information during execution of instructions to be executed by processor 1510 or 1505. Computing component 1500 may likewise include a read only memory (ROM) or other static storage device coupled to bus 1555 for storing static information and instructions for processor 1510 or 1505.

Computing component 1500 may also include one or more various forms of information storage devices 1520, which may include, for example, media drive 1530 and storage unit interface 1535. Media drive 1530 may include a drive or other mechanism to support fixed or removable storage media 1525. For example, a hard disk drive, a floppy disk drive, a magnetic tape drive, an optical disk drive, a CD or DVD drive (R or RW), or other removable or fixed media drive may be provided. Accordingly, removable storage media 1525 may include, for example, a hard disk, a floppy disk, magnetic tape, cartridge, optical disk, a CD or DVD, or other fixed or removable medium that is read by, written to or accessed by media drive 1530. As these examples illustrate, removable storage media 1525 may include a computer usable storage medium having stored therein computer software or data.

In alternative embodiments, information storage devices 1520 may include other similar instrumentalities for allowing computer programs or other instructions or data to be loaded into computing component 1500. Such instrumentalities may include, for example, fixed or removable storage unit 140 and storage unit interface 1535. Examples of such removable storage units 140 and storage unit interfaces 1535 may include a program cartridge and cartridge interface, a removable memory (for example, a flash memory or other removable memory component) and memory slot, a PCMCIA slot and card, and other fixed or removable storage units 1540 and storage unit interfaces 1535 that allow software and data to be transferred from removable storage unit 1540 to computing component 1500.

Computing component 1500 may also include a communications interface 1550. Communications interface 1550 may be used to allow software and data to be transferred between computing component 1500 and external devices. Examples of communications interface 150 include a modem or softmodem, a network interface (such as an Ethernet, network interface card, WiMedia, IEEE 802.XX, or other interface), a communications port (such as for example, a USB port, IR port, RS232 port Bluetooth® interface, or other port), or other communications interface. Software and data transferred via communications interface 1550 may typically be carried on signals, which may be electronic, electromagnetic (which includes optical) or other signals capable of being exchanged by a given communications interface 1550. These signals may be provided to/from communications interface 1550 via channel 1545. Channel 1545 may carry signals and may be implemented using a wired or wireless communication medium. Some non-limiting examples of channel 1545 include a phone line, a cellular or other radio link, an RF link, an optical link, a network interface, a local or wide area network, and other wired or wireless communications channels.

In this document, the terms “computer program medium” and “computer usable medium” are used to generally refer to transitory or non-transitory media such as, for example, main memory 1515, storage unit interface 1535, removable storage media 1525, and channel 1545. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions may enable the computing component 1500 or a processor to perform features or functions of the present application as discussed herein.

Although the disclosed technology is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the components or functionality described or claimed as part of the component are all configured in a common package. Indeed, any or all of the various components of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A neural network comprising:
a fully-connected neural layer that implements a generalized bundling function to transform a first set of symbols into a second set of symbols, wherein:
the generalized bundling function comprises a bundling operation that uses a weight matrix to influence amounts by which individual values of symbols of the first set of symbols contribute to the second set of symbols, and
the amounts by which the individual values of the symbols of the first set of symbols contribute to the second set of symbols vary based on the individual values of the symbols of the first set of symbols.

2. The neural network of claim 1, wherein:
in accordance with the weight matrix being a first size, the fully-connected layer transforms the first set of symbols to a different dimensionality in the second set of symbols; and
in accordance with the weight matrix being a second size, the fully-connected layer transforms the first set of symbols to a same dimensionality in the second set of symbols.

3. The neural network of claim 1, wherein:
the first set of symbols comprises a first set of Fourier holographic reduced representation (FHRR) vector-symbolic architecture (VSA) symbols; and
the second set of symbols comprises a second set of FHRR VSA symbols.

4. The neural network of claim 3, wherein the neural network further comprises:
a residual block comprising the fully-connected neural layer and a skip connection, wherein:
the fully-connected neural layer implements the generalized bundling function to transform the first set of FHRR VSA symbols into the second set of FHRR VSA symbols; and
the skip connection binds the first set of FHRR VSA symbols with the second set of FHRR VSA symbols or a set of FHRR VSA symbols derived from the second set of FHRR VSA symbols to produce a third set of FHRR VSA symbols.

5. The neural network of claim 4, further comprising:
a projection transformation that transforms classifiable inputs into unnormalized FHRR VSA symbols representing the classifiable inputs; and
a normalization transformation that normalizes the unnormalized FHRR VSA symbols to produce the first set of FHRR VSA symbols.

6. The neural network of claim 4, further comprising:
a similarity operation that compares the third set of FHRR VSA symbols to class symbols represented in a FHRR VSA vector space.

7. The neural network of claim 4, wherein:
the residual block further comprises a second fully-connected neural layer;
the second fully-connected neural layer implements a second generalized bundling function to transform the second set of FHRR VSA symbols into a fourth set of FHRR VSA symbols;
the second generalized bundling function comprises a bundling operation that uses a second weight matrix to influence amounts by which individual values of symbols of the second set of FHRR VSA symbols contribute to the fourth set of FHRR VSA symbols; and
the skip connection binds the first set of FHRR VSA symbols with the fourth set of FHRR VSA symbols to produce the third set of FHRR VSA symbols.

8. The neural network of claim 7, wherein:
according to size of the weight matrix, the fully-connected neural layer dimensionality of the second set of FHRR VSA symbols is double dimensionality of the first set of FHRR VSA symbols; and
according to size of the second weight matrix, dimensionality of the fourth set of FHRR VSA symbols is half the dimensionality of the second set of FHRR VSA symbols.

9. The neural network of claim 8, wherein the fully-connected neural layer is twice as wide as the second fully-connected neural layer.

10. The neural network of claim 1, wherein the generalized bundling function further comprises a bias that moves an origin of complex values output from the generalized bundling function from 0+0i to 1+0i.

11. The neural network of claim 1, further comprising:
a three-head fully-connected neural layer collection that converts the first set of symbols to query, key, and value symbols representing the first set of symbols, wherein:
the second set of symbols comprises the query symbols,
the three-head fully-connected neural layer collection comprises:
the fully-connected neural layer that implements the generalized bundling function to transform the first set of symbols into the query symbols,
a second fully-connected neural layer that implements a second generalized bundling function to transform the first set of symbols into the key symbols, and
a third fully-connected neural layer that implements a third generalized bundling function to transform the first set of symbols into the value symbols;
a symbolic query-key-value (QKV) attention operation that calculates and produces symbolic QKV attention symbols from the query, key, and value symbols output from the three-head fully-connected neural layer collection;
a first skip connection that binds the calculated symbolic QKV attention symbols with the first set of symbols to produce a third set of symbols; and
a residual block comprising a fourth fully-connected neural layer and a second skip connection, wherein:
the fourth fully-connected neural layer implements a fourth generalized bundling function that transforms the third set of symbols into a fourth set of symbols, and
the second skip connection binds the third set of symbols with the fourth set of symbols or a set of symbols derived from the fourth set of symbols to produce a fifth set of symbols.

12. The neural network of claim 11, wherein:
the residual block further comprises a fifth fully-connected neural layer;
the fifth fully-connected neural layer transforms the fourth set of symbols into a sixth set of symbols; and
the second skip connection binds the third set of symbols with the sixth set of symbols to produce the fifth set of symbols.

13. The neural network of claim 11, wherein:
dimensionality of the first set of symbols is (n);
dimensionality of the calculated symbolic QKV attention symbols is (n);
dimensionality of the third set of symbols is (n);
dimensionality of the fourth set of symbols is (2n);
dimensionality of the sixth set of symbols is (n); and
dimensionality of the fifth set of symbols is (n).

14. The neural network of claim 11, wherein the fourth fully-connected neural layer is twice as wide as the fifth fully-connected neural layer.

15. The neural network of claim 10, wherein:
the first set of symbols comprises a first set of FHRR VSA symbols.

16. The neural network of claim 15, further comprising:
a projection transformation that transforms classifiable inputs into unnormalized FHRR VSA symbols representing the classifiable inputs; and
a normalization transformation that normalizes the unnormalized FHRR VSA symbols to produce the first set of FHRR VSA symbols.

17. The neural network of claim 1, further comprising:
a trainable query operation that produces query symbols from a set of trainable symbols;
a two-head fully-connected neural layer collection that converts the first set of symbols to key and value symbols representing the first set of symbols, wherein:
the second set of symbols comprises the key symbols,
the two-head fully-connected neural layer collection comprises:
the fully-connected neural layer that implements the generalized bundling function to transform the first set of symbols into the key symbols, and
a second fully-connected neural layer that implements a second generalized bundling function to transform the first set of symbols into the value symbols;
a symbolic query-key-value (QKV) attention operation that calculates and produces symbolic QKV attention symbols from the query symbols output from the trainable query operation and the key and value symbols output from the two-head fully-connected neural layer collection;
a first skip connection that binds the calculated symbolic QKV attention symbols with the first set of symbols to produce a third set of symbols; and
a residual block comprising a third fully-connected neural layer and a second skip connection, wherein:
the third fully-connected neural layer implements a third generalized bundling function that transforms the third set of symbols into a fourth set of symbols, and
the second skip connection binds the third set of symbols with the fourth set of symbols or a set of symbols derived from the fourth set of symbols to produce a fifth set of symbols.

18. A deep neural network comprising:
a residual block comprising a fully-connected neural layer and a skip connection, wherein
the fully-connected neural layer implements a generalized bundling function to transform a first set of Fourier holographic reduced representation (FHRR) vector-symbolic architecture (VSA) symbols into a second set of FHRR VSA symbols,
the generalized bundling function comprises a bundling operation that uses a weight matrix to influence amounts by which individual values of symbols of the first set of FHRR VSA symbols contribute to the second set of FHRR VSA symbols,
the amounts by which the individual values of the symbols of the first set of FHRR VSA symbols contribute to the second set of FHRR VSA symbols vary based on the individual values, and
the skip connection binds the first set of FHRR VSA symbols with the second set of FHRR VSA symbols or a set of FHRR VSA symbols derived from the second set of FHRR VSA symbols to produce a third set of FHRR VSA symbols.

19. The deep neural network of claim 18, wherein:
in accordance with the weight matrix being a first size, the fully-connected neural layer transforms the first set of FHRR VSA symbols to a different dimensionality in the second set of FHRR VSA symbols; and
in accordance with the weight matrix being a second size, the fully-connected neural layer transforms the first set of FHRR VSA symbols to a same dimensionality in the second set of FHRR VSA symbols.

20. A method comprising:
using a generalized bundling function to transform a first set of Fourier Holographic Reduced Representation (FHRR) vector-symbolic architecture (VSA) symbols into a second set of FHRR VSA symbols, wherein:
the generalized bundling function comprises a bundling operation that uses a weight matrix to influence amounts by which individual values of symbols of the first set of FHRR VSA symbols contribute to the second set of FHRR VSA symbols, and
the amounts by which the individual values of the symbols of the first set of FHRR VSA symbols contribute to the second set of FHRR VSA symbols vary based on the individual values; and
binding the first set of FHRR VSA symbols with the second set of FHRR VSA symbols or a set of FHRR VSA symbols derived from the second set of FHRR VSA symbols to produce a third set of FHRR VSA symbols.
